(19) United States
(12) Patent Application Publication
(10) Pub. No.: US 2022/0121735 A1
(43) Pub. Date: Apr. 21, 2022

(54) Method of using sequence of biometric identities, gestures, voice input, characters, symbols and pictures, as a part of credentials for user authentication, and as a part of challenge for user verification

(71) Applicants: DHAVALKUMAR SHAH, OLD BRIDGE, NJ (US); NEHAL MEHTA, OLD BRIDGE, NJ (US)

(72) Inventors: DHAVALKUMAR SHAH, OLD BRIDGE, NJ (US); NEHAL MEHTA, OLD BRIDGE, NJ (US)

(21) Appl. No.: 17/478,904

(22) Filed: Sep. 18, 2021

Related U.S. Application Data
(63) Continuation-in-part of application No. 16/030,386, filed on Jul. 9, 2018.

(51) Int. Cl. G06F 21/32; G06F 21/45; G06F 21/36; G06K 7/14

(52) U.S. Cl. CPC G06F 21/32; G06F 21/45; G06F 21/36; G06F 2221/2137; G06K 7/1417; G06F 2221/2117; G06K 7/1413

(57) ABSTRACT

We propose a method that uses sequence of biometric identities, gestures, voice input, characters, symbols and pictures, for user authentication and verifications. So, user credential would be combination of “What he/she is and what he/she knows”.

User can create credential sequence using either same biometric identity or combination of two or more different biometric identity types, plain characters, formatted characters, unformatted symbol, formatted symbol, unformatted picture and formatted picture where any of these credential sub-member may or may not be present in the sequence created as user credential.

### RELATED APPLICATIONS

This patent application is a continuation-in-part application of U.S. patent application Ser. No. 16/030,386 filed on 9 Jul. 2018, still pending, with title “Method of using sequence of biometric identities, gestures, voice input, characters, symbols and pictures, as a part of credentials for user authentication, and as a part of challenge for user verification”.

### BACKGROUND OF THE INVENTION

The proposed invention concerns security. In particular, proposed method is to provide/improve/strengthen security for individual's any kind of data, information, credit, finances, services obtained (online and or offline), authenticate application user using sequence of his/her biometric identities, gestures, voice input, characters, symbols and pictures—What he/she is and What he/she knows.

Users are required to positively authenticate for gaining physical access to various places including Offices, Homes, Restricted Area, Schools, Private Property, Government Property and any area where user has to prove that he has rights to enter. User are also required to positively authenticate themselves to unlock smartphone, unlock computers, access software applications, access websites, approve transactions, approve payments, prove as beneficiary of programs, schemes and so on.

### BRIEF DESCRIPTION OF THE SEVERAL VIEWS OF THE DRAWING

Flowcharts

FIG. 1. Enrollment Workflow
User performs enrollment, registers his biometric identities to be used for credentials sequence and also gets user identifier for his enrollment

FIG. 2. Authentication Workflow

FIG. 3. Collecting Biometric identities to be used for System Verification for authentication and user verification

FIG. 4. Verification Workflow

Examples of Biopasscode

FIG. 5 (A) Biopasscode made up of finger prints from both the hands as indicated. User has chosen second finger of left hand and third and fifth from right hand in given order to create his passcode.

FIG. 5 (B) Biopasscode made up of two finger prints and one toe print as arranged. User uses sensors to capture finger prints and toe print.

FIG. 5 (C) Biopasscode made up of special character, two symbols/small pictures, two alphabets and one number.

FIG. 5 (D) Biopasscode made up of special character, symbols, alphabet, finger print and number. He uses key board and mouse as need to input symbols, alphabets and number and uses sensor to capture finger print and arranges it as per his sequence.

FIG. 5 (E) Biopasscode made up of two symbols, one alphabet and one number.

FIG. 5 (F) Biopasscode made up of two special characters, one alphabet and one voice input. User inputs the characters, alphabet and records the voice input. He inputs credential items as per sequence to start with or rearranges the credential parts as per his sequence before he submits.

FIG. 5 (G) Biopasscode made up of two special characters, finger print and number,

FIG. 5 (H) Biopasscode made up of finger print, alphabet, formatted number, colored symbol and voice input. So user has used total 5 different types of credentials members to create his unique sequence.

FIG. 5 (I) Biopasscode made up of alphabet, formatted number, colored symbol picture and colored emoji picture.

FIG. 5 (J) Biopasscode made up of formatted Alphabet, formatted special character and voice input. Here user has used three types of credential members.

FIG. 5 (K) Biopasscode made up of two formatted numbers, special character and formatted alphabet.

FIG. 5 (L) Biopasscode made up of colored shape, colored alphabet, colored picture in different colors, symbol and number. User chooses to use different credential member types and formats some of them to create his sequence.

FIG. 5 (M) Biopasscode made up of one finger print each from both hands and voice input.

FIG. 5 (N) Biopasscode made up of two finger prints from right hand and one finger print from left hand. One of the finger print of right hand is submitted in blue ink color.

FIG. 5 (O) Biopasscode made up of special character, formatted alphabet and gesture.

FIG. 5 (P) Biopasscode made up of finger print, gesture and voice input. User uses sensor to submit his finger print, camera captures his gesture and microphone captures voice input. The sequence in which user submitted these three items becomes his passcode.

FIG. 5 (Q) Biopasscode is created by submitting formatted shape, formatted picture, formatted alphabet, formatted special character and finger print colored in blue ink.

FIG. 5 (R) Biopasscode made up of styled special character, formatted special character, finger print in blue ink, formatted symbol, formatted alphabet.

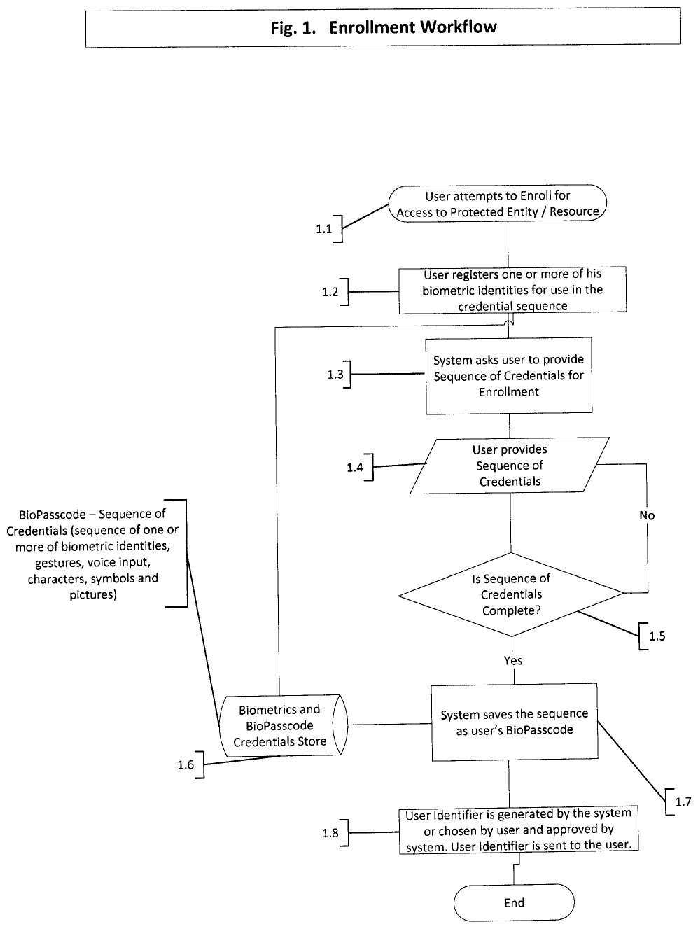

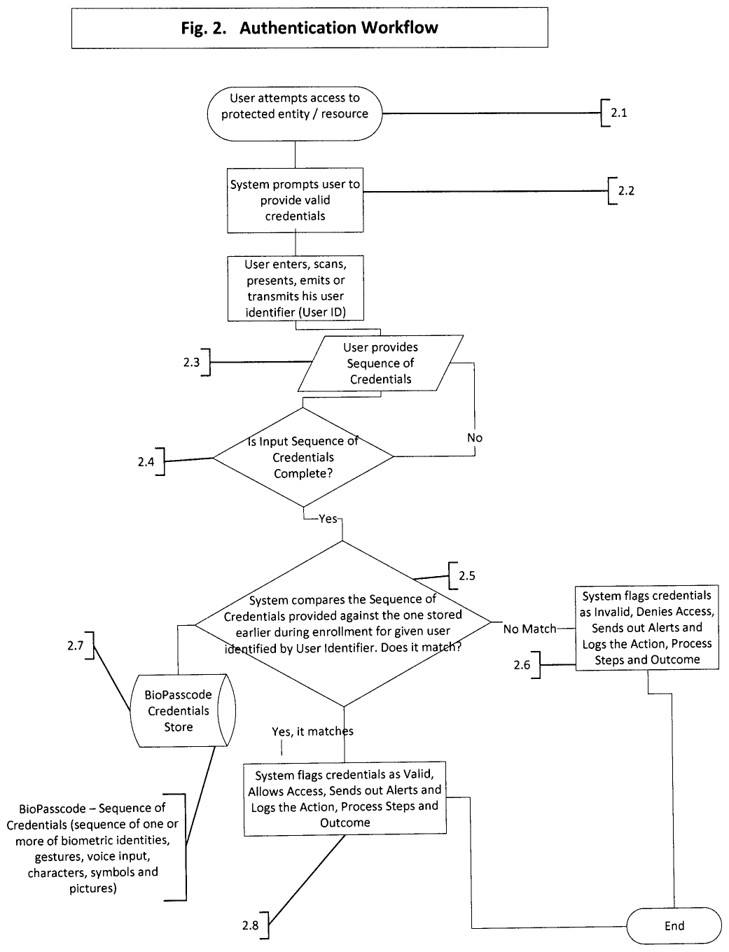

### BRIEF SUMMARY OF THE INVENTION

Advent of biometrics gave hope that identity cannot be stolen. But instances of finger print reproduced on special type of paper and used to unlock accounts instead of real finger print rang alarms. There is another danger. If person is unconscious or without his/her knowledge puts finger on finger print scanner, account would be unlocked. Same way palm vein and other biometric authentication means can be used to identify person but if person is unaware whether unconscious or unknowingly provides biometric identity his/her account would be compromised. Person can be tricked in many ways to provide their biometrics. This is wrong and there should be some solution for it.

We propose a method that fortifies biometric based user authentication and biometric based user verification with user known sequence of biometric and other identities.

As per our method, user provides sequence of one or more biometric and other identities for user authentication and verifications. Examples of biometric identities are finger prints, toe prints, knee scan, iris scan, palm vein and any other body feature or parts' that uniquely identifies a person. He may use gestures, voice input, characters, symbols and pictures to further strengthen the credential.

### DETAILED DESCRIPTION OF THE INVENTION

Our method allows user to create sequence of biometric identities, characters, symbols and pictures, for user authentication, e-signature and verifications. So, user credential would be combination of “What he/she is and what he/she knows”.

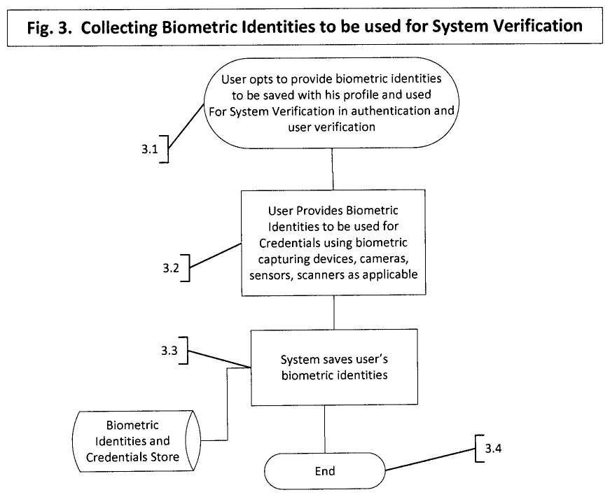

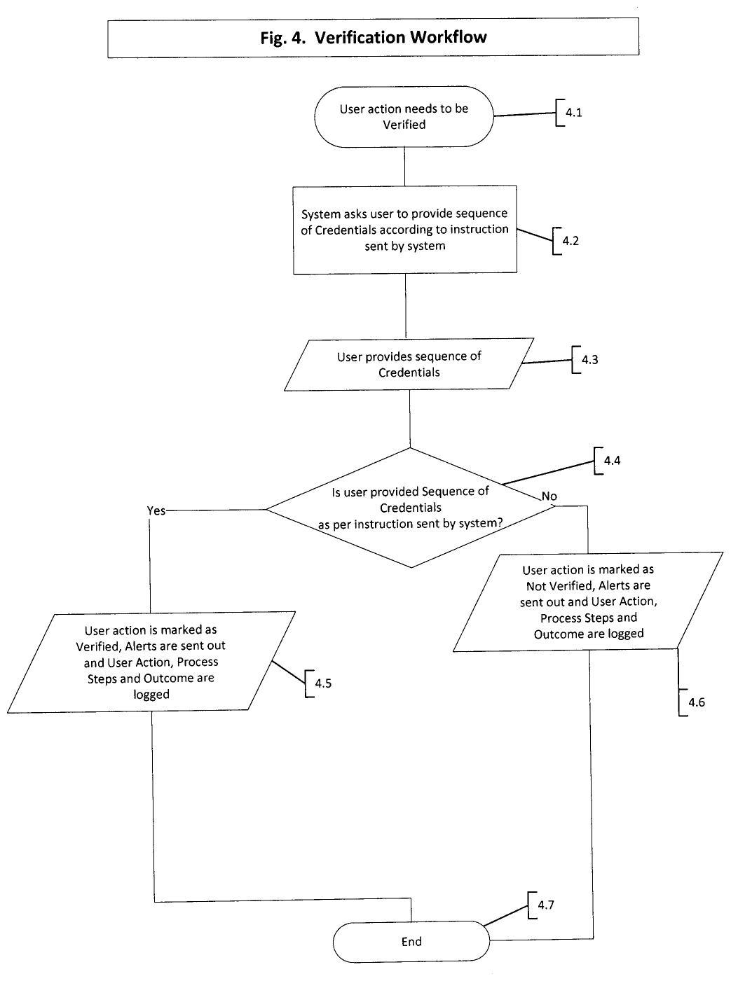

Before requesting access to the protected entity or protected resource, user performs enrollment. User registers one or more of his biometric identities as per FIG. 3 and uses it to create and provide sequence of credentials that are stored in the credentials store as per enrollment workflow in FIG. 1.

At the end of the enrollment, user has user identifier also commonly called User ID.

User can provide his Email Id, Social Security Number (SSN), Tax identification Number (TIN), phone number or any other assigned id, any string or number to designate as user identifier. If such user identifier is found unique i.e, not claimed by any other user as his User ID and not assigned to any previous user as User ID, system will allow it to be used as user identifier (User ID).

User can also let system generate user identifier using his attributes like last name, first name, and some numeric value so as to arrive at a string that is unique and never assigned to any user previously. e.g. SmithW23, ShahD27 . . . The numeric value will be a random number generated using a random function available in the technical environment where user is being registered.

User ID generated can also be an incremental number (number that is increased by given interval each time, usually 1) or random generated string using text and numbers or just numbers using random function available in the environment. e.g. ag33f4r53d33, 933844333, 1000001, 1000002, and so on.

E.g. Random class in Microsoft's .net platform is available via system.runtime.dll that exposes Random.Next, Random.Next(min,max), and other useful functions. Similar functions are available in all other platforms and languages. Such functions helps get random number using given upper bound. Same function can be used repeatedly with lower upper bound to generate string using pool of possible upper-case alphabets, lower-case alphabets and numbers. The random number generation method in these functions use base seed value, system timer, current seed value and some large numbers local to the environment. Random numbers do recycle within given range so as to avoid the predictability of the algorithm result for next number.

System can send user his User ID in form of text, barcode, QR code, both text and barcode or text and QR code to his email, text message, printed document in mail to his registered address, displayed text, barcode, QR code to his computer device, mobile phone, smart watch, smart glasses, tablet or sent to his app on mobile phone, smart watch, smart glasses, electronic arm band, electronic wrist band, computer device or tablet. System may also send user physical card with embedded chip that stores his user id or physical document with User Id in plain text or physical document with Barcode or QRCode or Image representing his User Id to his registered address.

User enters user id in online systems, kiosks, terminals, handheld devices, smartphones or any place where he is required to authenticate to gain access to protected entity or resource. User may also scan the barcode, QR code, image, picture, card with embedded chip, present electronic device like mobile, smart watch, smart glasses, smart card or tablet device that represents, emits or transmits his user identifier (user id) using technologies like Bluetooth, RFID (Radio Frequency Identification), WiFi, NFC (Near Field Communication), Zigbee and others as available.

Paragraphs [0003] to [0009] are not claimed as invention as many other authentication systems also uses same method to enroll users, assign user id and present user id for authentication and is common knowledge in Information Technology industry.

Along with user Id, user enters credential sequence made of up biometric and/or non-biometric parts as claimed in this invention when requesting access to the protected entity or protected resource.

Examples of biometric identities are finger prints, toe prints, knee scan, iris scan, palm vein and any other body parts' image or scan that uniquely identifies a person.

User may use gestures of same or different types as part of the credential.

Examples of characters are alphabets in any language, numbers and special characters like @, #, $, ˜, · and any other available for input.

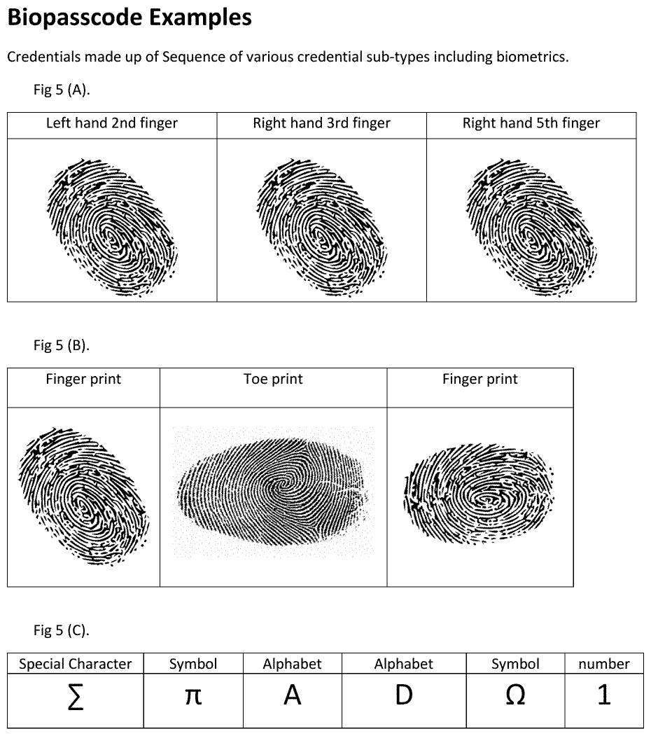

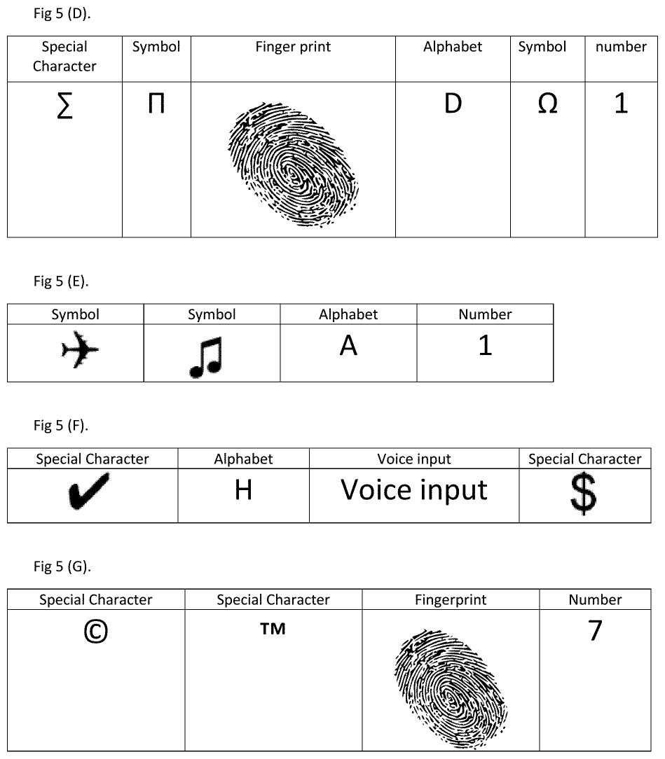

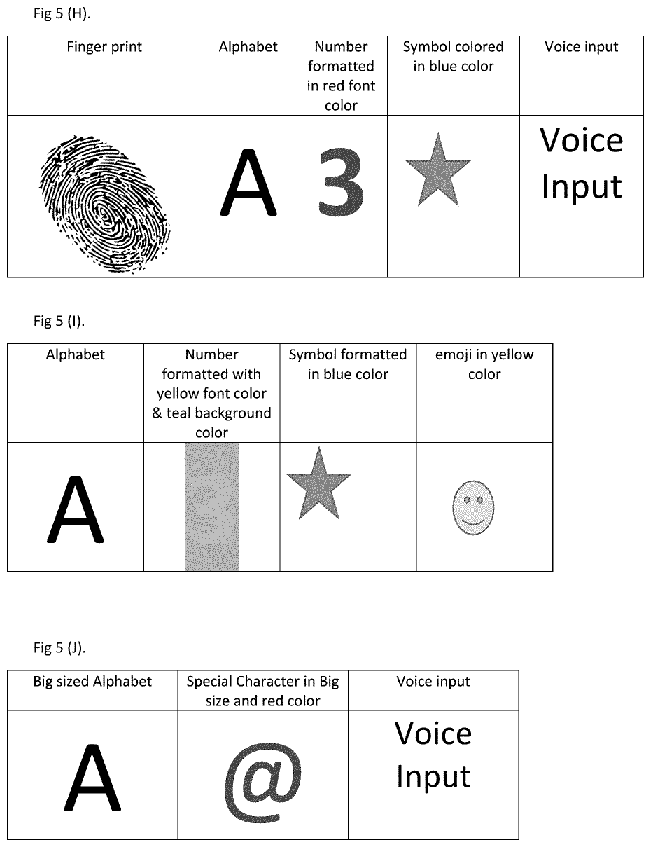

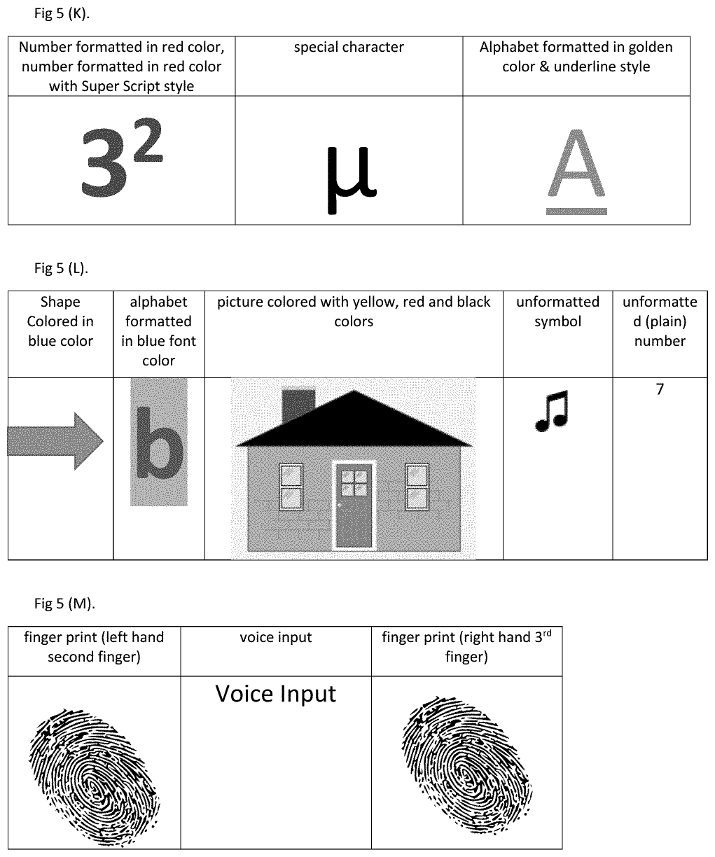

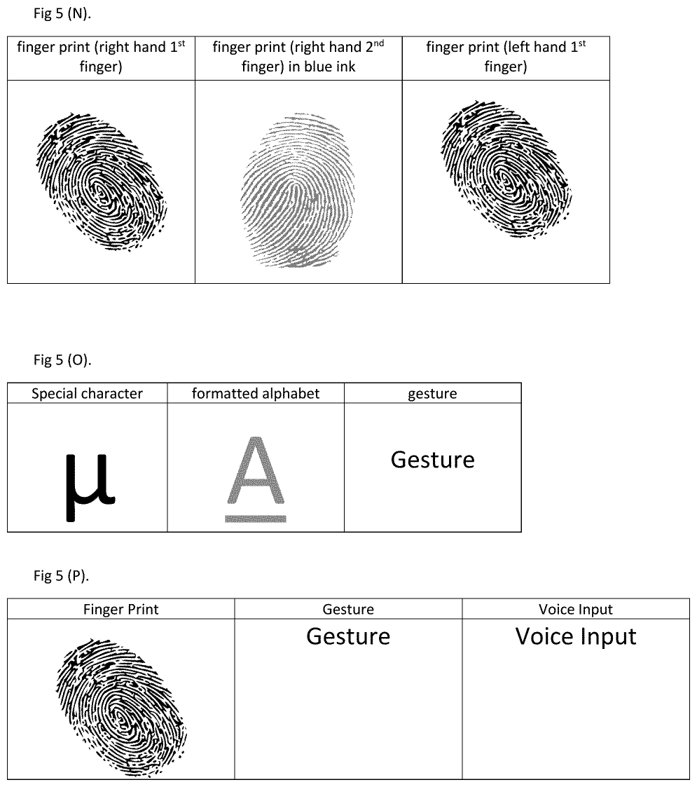

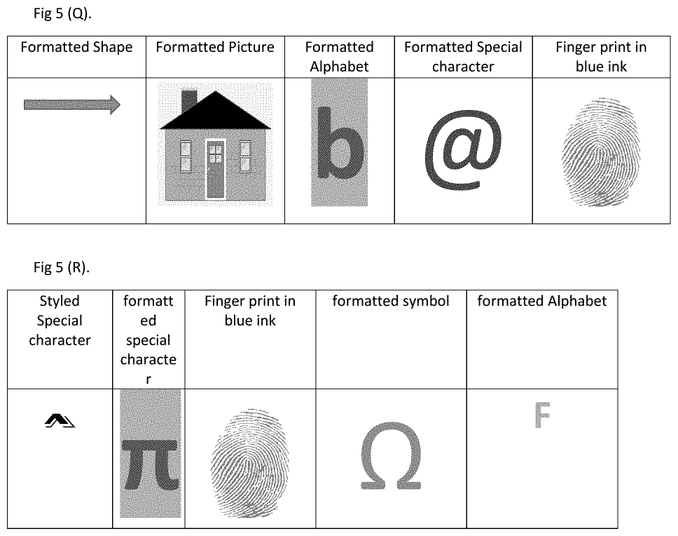

Examples of Symbols and Picture can be any emoticons, emoji's, image, photo or drawing. Even user's finger print images can be used as picture and can be formatted with some color as shown in example drawing FIG. 5 (Q) where finger print is colored in blue ink.

Characters can be plain or formatted using formatting options of color, shading, font styles—bold, italic, underline, strikeout, superscript, subscript, font name, font size and other available formatting options.

Symbols and picture can be used as it is or may be formatted using picture formatting options like coloring, rotating, tinting, cropping, pinching and other available picture formatting options.

User can create credential sequence using either same biometric identity or combination of two or more different biometric identity types, non-biometric parts like plain characters, formatted characters, unformatted symbol, formatted symbol, unformatted picture and formatted picture where any of these credential sub-member may or may not be present in the sequence created as user credential.

User may use input devices including keyboard, mouse, voice input or gestures to input and optionally format characters, symbols and pictures.

Biometric Input Devices, Sensors and Cameras would capture user biometric identities. Sensors and Cameras would capture user gestures.

We will call our method “Biopasscode” for easy reference in text below.

Examples of our method (current invention) but not limited to:

a) John wants to enroll in BioPasscode authentication. He provides finger print of fingers in following sequence. LH2RH2RH4LH1 where LH2—Left hand's second finger, RH2—Right hand's second finger, RH4—Right hand's 4^{th} finger, LH1—Left hand's first finger. This becomes his unique biometric passcode.
b) Henry wants to enroll in BioPasscode authentication. He provides finger and toe prints in following sequence. LH2RH2RF1LF5 where LH2—Left hand's second finger, RH2—Right hand's second finger, RF1—Right feet's 1st finger, LF5—Left feet's fifth finger. This becomes his unique biometric passcode.
c) Jolly wants to enroll in BioPasscode authentication, He provides biometric identities in following sequence. LH2RH2RPLP where LH2—Left hand's second finger, RH2—Right hand's second finger, RP—Right Palm scan, LP—Left Palm Scan. This becomes his unique biometric passcode.
d) Tom wants to enroll in BioPasscode authentication, He provides biometric identities in following sequence. LKRH2RPRK where LK—Left knee scan, RH2—Right hand's second finger, RP—Right Palm scan, RK—Right Knee Scan. This becomes his unique biometric passcode.
e) Heli wants to enroll in BioPasscode authentication. She creates credential sequence as: LH2X <P1y>

where LH2—Left hand's second finger, X—Alphabet char ‘X’ and <P1>—Picture tinted in yellow color. This becomes her unique biometric passcode.

f) Molly wants to enroll in BioPasscode authentication. She creates credential sequence as: R<E1> <P1>RH3

where R—Alphabet char in Bold Style, <E1>—Emoticon, <P1>—Picture and RH3—Right hand's third finger. This becomes her unique biometric passcode.

g) Trisha wants to enroll in BioPasscode authentication. She creates credential sequence as: <E2>RH1LH2 9

where <E2>—Emoticon, RH1—Right hand's first finger, LH2—Left hand's second finger and 9—Number in italic style, Red font color and grey background. This becomes her unique biometric passcode.

h) Sara wants to enroll in BioPasscode authentication. She creates credential sequence as: RH2LH2 [symbol] #

where RH2—Right hand's second finger, LH2—Left hand's second finger and ‘Code’ is underlined alphabets, 2—Number which is strike out with white font color and black background (shading). ‘Code’ is in yellow font color and black background color (shading). #is in black font and grey background (shading). This becomes her unique biometric passcode.

i) Sneha wants to enroll in BioPasscode authentication. She creates credential sequence as: RH1G1V1

where RH1—Right hand's first finger, G1—Gesture 1 out of one of more gestures defined by user, V1—Voice input 1 out of one or more voice input defined by user. This becomes her unique biometric passcode.

j) Trisha wants to access the server room, a protected entity secured by current invention, She needs to provide her identification and credentials at access control device (computer with touchscreen, smart card reader, biometric input devices, cameras, sensors). She scans her smart card in front of the smart card reader, her User identifier (User ID) gets transmitted to the access control device. Now she provides her sequence of credentials to the access control device. She gets validated and allowed access to the server room if her credentials are correct for user identifier she presented via the smart card. If any of the biometric identity or non-biometric part is incorrect then Trisha is not allowed access. If all biometric identities are correct but sequence is incorrect, still Trisha is not allowed access. Assume Trisha's correct sequence of credentials are as per subsection g) above. ie. <E2>RH1LH2 9 In this sequence there are two biometric and two non-biometric identities. Biometric identities are Right hand First finger and Left hand Second finger. Even if both biometric identities are matching, if user don't input number 9 in red color, italic style and grey background access is denied. If user don't input the sequence in right order, user is just told he gave invalid credentials and access is denied. In this example, to get access, user's biometric identities has to be matched, in right sequence with other non-biometric identities and non-biometric parts also have to be correct and in right order.
k) Trisha is trying to access her stock trading app on her smartphone secured by current invention, Trisha's credential is as per FIG. 5 (N) made up of credential sequence of two finger prints from right hand and one finger print from left hand (RH1RH2(blue)LH1). Finger print of right hand's second finger is in blue color. Trisha can type in her user identifier (User ID) in login form or in other variation can scan the OR code representing her user identifier (User ID) or in another variation. After providing her User ID, she proceeds to credential input page where she using her smartphone's finger print sensor provides finger prints as per her sequence. One of the finger print has to be in blue (second finger print of right hand) so she colors it in blue using onscreen color panel before she submits the credentials for access, if her finger prints match the finger prints she registered while enrolling with the stock trading app, and if they are in the correct sequence with given right hand finger print colored in blue, she is granted access to her stock trading account.

1. A computer-implemented process of authenticating a user requesting access to protected entity using credentials that are personalized using sequence made up of credential members such as one or more of user's biometric identities, gestures, voice input, plain characters, formatted characters, unformatted symbol, formatted symbol, unformatted picture and formatted picture, the process comprising the steps of:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, electronic wrist band, electronic arm band, tablet that emits or transmits his user id to the computer device trying to identify the user;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture; wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of the sequence and its order are considered as one individual credential must match to corresponding input to return true match;
using computer device for comparing the captured credentials against credentials that are designated by the user as valid credentials (during enrollment) prior to requesting access, wherein the credentials remain valid until user changes it or user resets it;
using computer device for flagging the captured credentials as valid and allowing the user to have access when the comparison indicates that a match occurs, flagging the captured credentials as invalid and rejecting the request for access when the comparison indicates that a match does not occur;
using computer device for alerting the user via alert communication methods chosen by the user including email, text message, Smartphone Notifications, voice message, voice call, SMS, audible alarm, or visual clues; and
using computer device for logging the user action, process steps and its outcome.

2. The process of claim 1, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

3. The process of claim 1, wherein the valid credentials are set for each time range and time range is of duration of minutes, a day, days, week, weeks, month, years, day of week or time period of the day.

4. An apparatus comprising:
one or more processors;
one or more biometric capturing devices;
a memory storing instructions that when executed by the one or more processors perform the steps comprising:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, smart card, electronic wrist band, electronic arm band, tablet that emits or transmits his user id to the computer device trying to identify the user;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture;
wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of the sequence and its order are considered as one individual credential must match to corresponding input to return true match;
using computer device for comparing the captured credentials against credentials that are designated by the user as valid credentials (during enrollment) prior to requesting access, wherein the credentials remain valid until user changes it or user resets it; using computer device for flagging the captured credentials as valid and allowing the user to have access when the comparison indicates that a match occurs, flagging the captured credentials as invalid and rejecting the request for access when the comparison indicates that a match does not occur;
using computer device for alerting the user via alert communication methods chosen by the user including email, text message, Smartphone Notifications, voice message, voice call, SMS, audible alarm, or visual clues; and
using computer device for logging the user action, process steps and its outcome.

5. The apparatus of claim 4, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

6. A non-transitory computer-readable medium having instructions stored thereon executable by a computing platform for:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, smart card, electronic wrist band, electronic arm band, tablet that emits or transmits his user id to the computer device trying to identify the user;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture;
wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of the sequence and its order are considered as one individual credential must match to corresponding input to return true match;
using computer device for comparing the captured credentials against credentials that are designated by the user as valid credentials (during enrollment) prior to requesting access, wherein the credentials remain valid until user changes it or user resets it;
using computer device for flagging the captured credentials as valid and allowing the user to have access when the comparison indicates that a match occurs, flagging the captured credentials as invalid and rejecting the request for access when the comparison indicates that a match does not occur;
using computer device for alerting the user via alert communication methods chosen by the user including email, text message, Smartphone Notifications, voice message, voice call, SMS, audible alarm, or visual clues; and
using computer device for logging the user action, process steps and its outcome.

7. The computer-readable medium of claim 6, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

8. A computer-implemented user authentication process that has an ability to be independently invoked for authenticating a user request to access a protected entity or to supplement authenticating a user requesting access to the protected entity, the process comprising the steps of:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, smart card, electronic wrist band, electronic arm band, tablet that emits or transmits his user id to the computer device trying to identify the user;
Using a computer device for delivering sequencing instructions, which instruct the user, how to sequence given list comprising of credential members such as one or more of user's biometric identities, characters, symbols and pictures, to the user over an alternate channel including Email, SMS, Smartphone Notification, voice message, picture message, video message, or hardware device given to user or accessible to user to receive instructions remotely;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture;
wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of sequence and its order are considered as one individual unit must match to corresponding input to return true match;
using computer device for comparing the captured sequence of credential member identities against a stored sequence of credential member identities on a server that is generated using same instructions sent to the user using the alternate channel;
using computer device for flagging the captured sequence of credential member identities as correct and alternate authentication process as success when the comparison indicates that a match occurs, flagging the captured sequence of credential member identities as incorrect and alternate authentication process as failure when the comparison indicates that a match does not occur;
alerting the user via alert communication methods chosen by the user including email, text message, Smartphone Notifications, voice message, voice call, SMS, audible alarm, or visual clues; and
using computer device for logging the user action, process steps and its outcome.

9. The process of claim 8, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

10. An apparatus comprising:
one or more processors;
one or more biometric capturing devices, sensors and cameras;
a memory storing instructions that when executed by the one or more processors perform the steps comprising:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, smart card, electronic wrist band, electronic arm band, tablet that emits or transmits his user id to the computer device trying to identify the user;
delivering sequencing instructions using computer device, which instruct the user, how to sequence given list comprising of credential members such as one or more of user's biometric identities, characters, symbols and pictures, to the user over an alternate channel including Email, SMS, Smartphone Notification, voice message, picture message, video message, or hardware device given to user or accessible to user to receive instructions remotely;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture;
wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of sequence and its order are considered as one individual unit must match to corresponding input to return true match;
using computer device for comparing the captured sequence of credential member identities against a stored sequence of credential member identities on a server that is generated using same instructions sent to the user using the alternate channel;
using computer device for flagging the captured sequence of credential member identities as correct and alternate authentication process as success when the comparison indicates that a match occurs, flagging the captured sequence of credential member identities as incorrect and alternate authentication process as failure when the comparison indicates that a match does not occur;
using computer device for alerting the user via alert communication methods chosen by the user including email, text message, Smartphone Notifications, voice message, voice call, SMS, audible alarm, or visual clues; and
using computer device for logging the user action, process steps and its outcome.

11. The apparatus of claim 10, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.

12. A non-transitory computer-readable medium having instructions stored thereon executable by a computing platform to perform the steps of:
User initially enrolling with the protected entity by registering one or more of his/her biometric identities to be used in creating credentials for authentication or for user verification challenge, registering credentials (credential sequence) and getting user identifier (user id) assigned by the system or user identifier is chosen by the user and approved by the system;
using computer device for identifying an enrolled user who is requesting access to protected entity by entering the user identifier (user id) or by scanning barcode, QR code, picture or image representing his user identifier (user id) or by scanning the card with chip storing his user id or by presenting electronic device including smartphone, smart watch, smart card, electronic wrist band, electronic arm band, tablet that emits or transmits his user id to the computer device trying to identify the user;
delivering sequencing instructions using computer device, which instruct the user, how to sequence given list comprising of credential members such as one or more of user's biometric identities, characters, symbols and pictures, to the user over an alternate channel including Email, SMS, Smartphone Notification, voice message, picture message, video message, or hardware device given to user or accessible to user to receive instructions remotely;
using computer device for capturing sequence from the user where sequence includes credential members such as one or more of user's biometric identities captured using biometric capturing devices, cameras or sensors, gestures captured using devices that include cameras or sensors, voice input captured using microphone, and non-biometric parts captured using computer input devices;
wherein the biometric identities comprise one or more of user's finger prints, toe prints, knee scan, iris scan, palm vein and any other body feature or body part's image or body part's scan that uniquely identifies a person;
wherein the non-biometric parts include plain characters, formatted characters, unformatted symbol, formatted symbol, unformatted picture and formatted picture;
wherein formatted characters are formatted using formatting options comprising Font, Font Size, Font Color, Shading, Font Style, Font Effects, Font Underline, and character effects;
wherein picture is an emoticon, emoji, drawing, image, shape or finger print image of any of the finger of user itself;
wherein formatted symbol and formatted picture are formatted using formatting options comprising of applying picture effects, tinting, filtering, folding, cropping, coloring, cutting, zooming, styling, picture bordering, and framing;
wherein the sequence is made up of at least two credential members with at least one credential member being biometric identity from user's finger prints, toe prints, knee scan, iris scan, palm vein and any other body feature or body part's image or body part's scan and while comparing, all credential members of sequence and its order are considered as one individual unit must match to corresponding input to return true match;
using computer device for comparing the captured sequence of credential member identities against a stored sequence of credential member identities on a server that is generated using same instructions sent to the user using the alternate channel;
using computer device for flagging the captured sequence of credential member identities as correct and alternate authentication process as success when the comparison indicates that a match occurs, flagging the captured sequence of credential member identities as incorrect and alternate authentication process as failure when the comparison indicates that a match does not occur;
using computer device for alerting the user via alert communication methods chosen by the user including email, text message, Smartphone Notifications, voice message, voice call, SMS, audible alarm, or visual clues; and
using computer device for logging the user action, process steps and its outcome.

13. The computer-readable medium of claim 12, wherein the user action is a request to access the protected entity, wherein the protected entity is a restricted physical area, restricted property, restricted media, lockers, safe deposit box, restricted items, software application, software service, website, web service, data, information, hardware device, mobile app, smartphone app, physical area, physical item, bank account, trading account, beneficiary account, credit limit, monetary balance, reward points, transaction approval, payment approval, computing device, smart phone, tablet, laptop, server or communication device.
